(19) United States
(12) Patent Application Publication
(10) Pub. No.: US 2008/0268698 A1
(43) Pub. Date: Oct. 30, 2008

(54) AUTOMATIC LOCK DETECT FOR A SOCKET

(76) Inventor: Samuel M. Babb, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/740,372

(22) Filed: Apr. 26, 2007

(51) Int. Cl. H01R 3/00

(52) U.S. Cl. 439/490

(57) ABSTRACT

A zero insertion force (ZIF) socket is disclosed wherein the ZIF socket has a locking mechanism movable between a locked position and an un-locked position. A light source is configured to emit light and a light detector is configured to output two states, a first state when exposed to light emitted by the light source and a second state when not exposed to light emitted by the light source. When the locking mechanism is moved from the un-locked position to the locked position the locking mechanism causes light emitted by the light source to be redirected such that the light detector changes from one of the two states to the other of the two states.

### BACKGROUND

Central processing units (CPU) are typically attached to the motherboard of a computer using a socket. Because of the high pin density on a CPU, the socket is typically a Zero Insertion Force (ZIF) socket. A normal Integrated Circuit (IC) socket requires the IC to be pushed into sprung contacts which then grip by friction. For an IC with hundreds of pins, the total insertion force can be very large (tens of newtons), leading to a danger of damage to the device during insertion. Low Insertion Force (LIF) sockets reduced the issues of insertion and extraction but the lower the insertion force of a conventional socket, the less reliable the connection is likely to be. With a ZIF socket, before the IC is inserted, a lever or slider on the side of the socket is moved, pushing all the sprung contacts apart so that the IC can be inserted with very little force (generally the weight of the IC itself is sufficient with no external downward force required). The lever is then moved back, allowing the contacts to close and grip the pins of the IC. ZIF sockets are much more expensive than standard IC sockets and also tend to take up a larger board area. Therefore ZIF sockets are typically used only for the most expensive IC's, for example the CPU.

ZIF sockets come in a variety of styles, for example the pin grid array (PGA) and the land grid array (LGA). The PGA socket operates by having the pins on the underside of the processor inserted into the socket. In contrast to this the land grid array (LGA) operates by having the pins on the socket side that come in contact with pads on the processor.

All ZIF sockets, including both PGA and LGA sockets, have a mechanism used to close or lock the IC in place once the IC has been inserted into the ZIF socket. The mechanism may activate using a sliding motion or a rotation. When the socket is inadvertently left unlocked, system failures typically occur. Depending on the geometry of the socket and the initial unlocked connection between the IC and the socket (if any), the failure may occur intermittently, or after some initial time period. Detecting an unlocked socket may be difficult once the printed circuit (PC) board has been installed into a device.

U.S. Pat. No. 6,786,761 by Benavides (Hereafter the '761 patent) discloses a system and method for sensing the status of a ZIF socket lever. The system and method taught by the '761 patent uses an electrical circuit traveling through the ZIF socket where the circuit is activated by using the ZIF socket lever to complete the circuit when in the locked position. Using the system and method taught by the '761 patent has a number of limitations. One limitation is that a number of pins in the ZIF socket are used to implement the method. As connector densities on IC's continue to increase, using pins on the socket for detecting when the socket is in the locked position is a disadvantage. Another issue is using the locking lever as part of the electrical circuit. This may limit the allowable geometries for the locking mechanism, or introduce grounding or RFI issues into the socket.

### BRIEF DESCRIPTION OF THE DRAWINGS

FIG. 1. is a block diagram top view of a ZIF socket in an example embodiment of the invention.

FIG. 2a. is a block diagram side view of a ZIF socket in an example embodiment of the invention.

FIG. 2b. is a block diagram side view of a ZIF socket in an alternate example embodiment of the invention.

### DETAILED DESCRIPTION

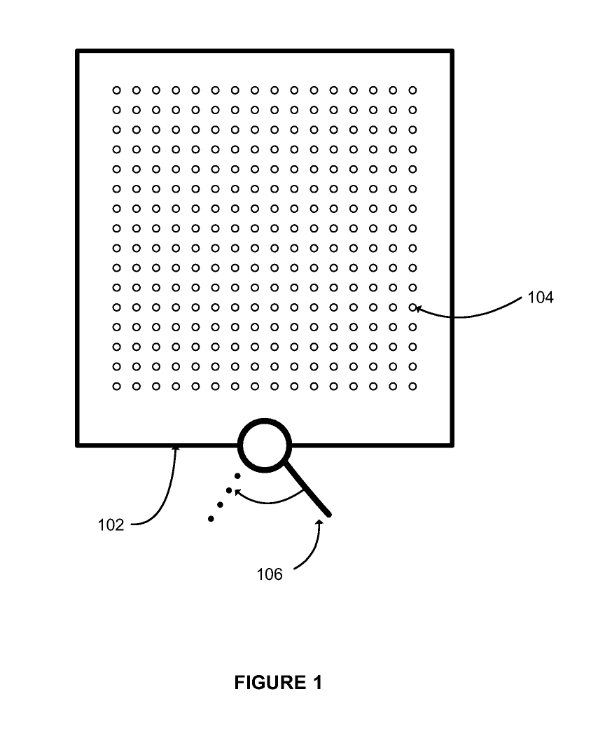

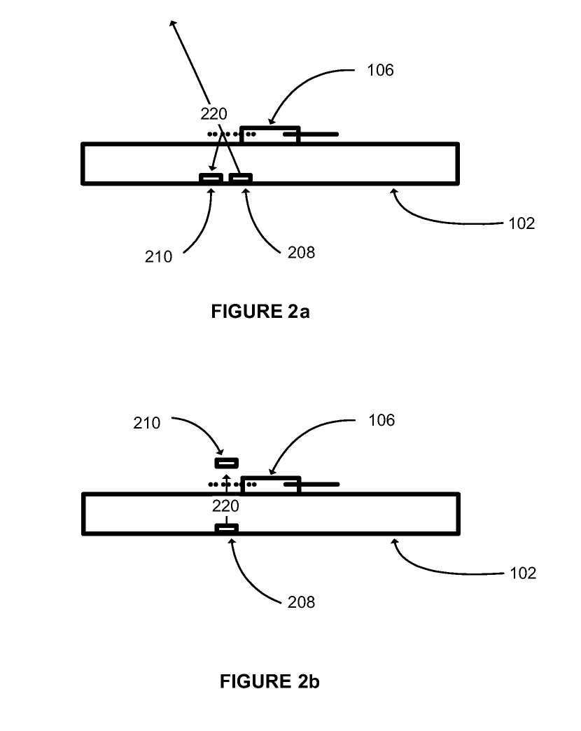

FIGS. 1-2b and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 is a block diagram top view of ZIF socket 102 in an example embodiment of the invention. ZIF socket 102 has a plurality of contact locations 104 and a locking mechanism 106. Locking mechanism 106 is shown in the un-locked position (As shown by the solid line). To lock ZIF socket 102, locking mechanism 106 is rotated clockwise, about an axis perpendicular to the plane defined by the ZIF socket, to the position indicated by the dashed line. Other types of locking motions may be used to lock a ZIF socket including a sliding motion, rotation about an axis contained in the plane defined by the ZIF socket, or the like. ZIF socket 102 may use any type of ZIF architecture including PGA and LGA architectures.

FIG. 2a is a block diagram side view of ZIF socket 102 in an example embodiment of the invention. ZIF socket 102 comprises a locking mechanism 106, a light source or emitter 208, and a light detector 210. When locking mechanism 106 is in the unlocked position (As shown by the solid line) the light 220 emitted by light source 208 travels upward and away from light detector 210. When locking mechanism 106 is in the locked position (As shown by the dashed line) the light 220 emitted by light source 208 travels upwards and then is redirected back towards light detector 210. The light may be redirected back towards light detector 210 by reflection, scattering, or the like. In one example embodiment of the invention, a reflector or flag may be attached to the end of locking mechanism 106 to help redirect the light into light detector 210.

Light detector 210 is configured to output at least two different states, a first state when exposed to light emitted by light source 208 and a second state when not exposed to light emitted by light source 208. Light detector 210 may be configured to respond primarily to light emitted by light source 208. In one example embodiment of the invention, a filter, that allows only light to pass that matches the frequency of light emitted by light source 208, may be attached to light detector 210. In another example embodiment of the invention, light detector may only be sensitive to the frequency of light emitted by light source 208. Light source 208 may be any type of device that emits light including, an incandescent bulb, a light emitting diode (LED), a laser, or the like.

In one example embodiment of the invention, light source 208 and light detector 210 may be mounted onto a printed circuit (PC) board next to where ZIF socket 102 is mounted. In this configuration, the light source 208 and light detector 210 do not use any of the pins in ZIF socket 102. In another example embodiment of the invention, light source 208 and light detector 210 may be mounted directly onto the ZIF socket 102. By using the redirection of light to detect when the ZIF socket is in the locked position, the ZIF socket can remain electrically isolated from the detection device or detection circuit.

FIG. 2b is a block diagram side view of ZIF socket 102 in an alternate example embodiment of the invention. ZIF socket 102 comprises a locking mechanism 106, a light source or emitter 208, and a light detector 210. When locking mechanism 106 is in the unlocked position (As shown by the solid line) the light 220 emitted by light source 208 travels upward and into light detector 210. When locking mechanism 106 is in the locked position (As shown by the dashed line) the light 220 emitted by light source 208 is blocked from reaching light detector 210. In one example embodiment of the invention, a flag may be attached to the end of locking mechanism 106 to help block the light from reaching light detector 210.

What is claimed is:

1. An apparatus, comprising:
a zero insertion force (ZIF) socket wherein the ZIF socket has a locking mechanism movable between a locked position and an un-locked position;
a light source configured to emit light;
a light detector wherein the light detector outputs two states, a first state when exposed to light emitted by the light source and a second state when not exposed to light emitted by the light source; and
when the locking mechanism is moved from the un-locked position to the locked position the locking mechanism causes light emitted by the light source to be redirected such that the light detector changes from one of the two states to the other of the two states.

2. The apparatus of claim 1, wherein the locking mechanism redirect the light emitted by the light source by blocking the light emitted by the light source from reaching the light detector, causing the light detector to switch from the second state to the first state when the locking mechanism is moved from the un-locked position to the locked position.

3. The apparatus of claim 1, where the locking mechanism redirect the light emitted by the light source by reflecting the light emitted by the light source into the light detector, causing the light detector to switch from the first state to the second state when the locking mechanism is moved from the un-locked position to the locked position.

4. The apparatus of claim 1, wherein when moving from the un-locked position to the locked position the locking mechanism uses a motion selected from the group consisting of a sliding motion and a rotary motion.

5. The apparatus of claim 1, wherein the light source is a light emitting diode (LED).

6. The apparatus of claim 1, wherein the ZIF socket, the light source and the light detector are mounted onto a printed circuit (PC) board.

7. The apparatus of claim 1, wherein the light source and the light detector are mounted onto the ZIF socket.

8. The apparatus of claim 1, wherein the ZIF socket is selected from the group consisting of a PGA socket and a LGA socket.

9. A method for detecting when a ZIF socket is locked, comprising:
emitting light from a light source;
detecting a change in the light from the light source when a ZIF socket locking mechanism moves from an un-locked position to a locked position wherein the ZIF socket locking mechanism, when moved from the un-locked position to the locked position, redirects the emitted light from the light source such that a light detector changes from one of two states to the other of the two states, wherein the light detector outputs a first state when exposed to light emitted by the light source and outputs a second state when not exposed to light emitted by the light source.

10. The method of claim 9, wherein the locking mechanism redirect the light emitted by the light source by blocking the light emitted by the light source from reaching the light detector, causing the light detector to switch from the second state to the first state when the locking mechanism is moved from the un-locked position to the locked position.

11. The method of claim 9, wherein the locking mechanism redirect the light emitted by the light source by reflecting the light emitted by the light source into the light detector, causing the light detector to switch from the first state to the second state when the locking mechanism is moved from the un-locked position to the locked position.

12. The method of claim 9, wherein when moving from the un-locked position to the locked position the locking mechanism uses a motion selected from the following group a sliding motion and a rotary motion.

13. The method of claim 9, wherein the light source is a light emitting diode (LED).

14. The method of claim 9, wherein the ZIF socket, the light source and the light detector are mounted onto a printed circuit (PC) board.

15. The method of claim 9, wherein the light source and the light detector are mounted onto the ZIF socket.

16. The apparatus of claim 9, wherein the ZIF socket is selected from the group consisting of a PGA socket and a LGA socket.

17. A method for manufacturing a system that detects the status of a locking mechanism for a ZIF socket, the method comprising:
mounting a zero insertion force (ZIF) socket onto a printed circuit (PC) board wherein the ZIF socket has a locking mechanism movable between a locked position and an un-locked position;
mounting a light source configured to emit light onto the PC board;
mounting a light detector onto the PC board wherein the light detector outputs two states, a first state when exposed to light emitted by the light source and a second state when not exposed to light emitted by the light source wherein when the locking mechanism is moved from the un-locked position to the locked position the locking mechanism causes light emitted by the light source to be redirected such that the light detector changes from one of the two states to the other of the two states.

18. A method for manufacturing a system that detects the status of a locking mechanism for a ZIF socket, the method comprising:
mounting a zero insertion force (ZIF) socket onto a printed circuit (PC) board wherein the ZIF socket has a locking mechanism movable between a locked position and an un-locked position;
mounting a light source configured to emit light onto the ZIF socket;
mounting a light detector onto the ZIF socket wherein the light detector outputs two states, a first state when exposed to light emitted by the light source and a second state when not exposed to light emitted by the light source wherein when the locking mechanism is moved from the un-locked position to the locked position the locking mechanism causes light emitted by the light source to be redirected such that the light detector changes from one of the two states to the other of the two states.
